(19) United States
(12) Patent Application Publication
(10) Pub. No.: US 2008/0258964 A1
(43) Pub. Date: Oct. 23, 2008

(54) Radar System

(76) Inventors: Thomas Schoeberl, Hildesheim (DE); Thomas Focke, Ahrbergen (DE); Thomas Hansen, Hildesheim (DE); Martin Schneider, Menslage (DE); Joerg Schoebel, Salzgitter (DE); Volker Gross, Ditzingen (DE); Oliver Brueggemann, Ilsede (DE)

Correspondence Address: KENYON & KENYON LLP, ONE BROADWAY, NEW YORK, NY, 10004, US

(21) Appl. No.: 11/793,123

(22) PCT Filed: Nov. 18, 2005
(86) PCT No.: PCT/EP2005/056062

§ 371 Date: Apr. 4, 2008

(30) Foreign Application Priority Data
Dec. 13, 2004 (DE) 1020040599157

(51) Int. Cl. G01S 13/00

(52) U.S. Cl. 342/189

(57) ABSTRACT

In a radar system, a switcher is provided for switching over between at least two different directional characteristics, in particular for different distance ranges, of at least two transmitting antennas. On the receiving side, a combined evaluation of the digitized signals of at least two receiving antennas is performed, in the manner of a correlation of the receiving antenna signals.

### FIELD OF THE INVENTION

The present invention concerns a radar system having at least two transmitting antennas having different directional characteristics.

### BACKGROUND INFORMATION

Radar sensors (primarily in the 76-77 GHz frequency region) have been in use for several years in the field of driver-assistance functions with predictive sensing systems. These sensors are at present still being used in the higher-end sector to implement the “adaptive cruise control” (ACC) assistance function in the 30-180 km/h speed range.

The radar sensors available on the market at present are characterized by the following properties: range of up to approx. 120-150 m
horizontal sensing in the range +/−4°+/−10°
angular accuracy of approx. 0.5°.

One limitation of present-day sensors is that the physical depth is relatively large, and vehicle manufacturers' need for substantially flatter sensors can be only insufficiently met.

The restricted horizontal sensing width resulting from the antenna concepts that have been selected is likewise disadvantageous, for example because “cutting-in” vehicles can be detected only at a very late point in time, or relevant objects disappear more often from the “field of view” in sharp curves. A widening of the field of view in the short- to medium-distance range is absolutely necessary here, in particular for an automatic slow-traffic following process. Ideas being considered at present in this area include the use of additional sensors such as video or, for the ultra-short range down to approx. 3 m, ultrasonic sensors.

A further substantial limitation may be seen in the fact that while the radar sensors used hitherto can very precisely determine the angular offset of objects in the aforesaid horizontal sensing region (angular accuracy), this is in general reliably possible only if only one object, at a specific distance and at a specific relative velocity, is to be sensed. If two or more objects are located at the same distance and if, in some circumstances, they also have the same velocity, present-day radar sensors can separate individual objects from one another only if the radar lobe, or the half-power width of the radar lobe, is narrower than the angular spacing of the objects to be separated. For a specific half-power width of an antenna beam at a given frequency or wavelength, however, a specific antenna aperture size is necessary. For a circular antenna aperture having a diameter D and a constant coverage, the following correlation is approximately true for the half-power width ν (in degrees):

$$υ \approx 59 ° \frac{λ}{D}$$

for a wavelength λ (=3.9 mm at 77 GHz). For example, if an angular separation of at least 2° is to be achievable, then according to the equation above an aperture diameter D≧115 mm would already need to be selected. This is not acceptable for an ACC sensor, since the maximum permissible overall size is limited to much smaller dimensions. On the other hand, a separation capability of this kind (approx. 2° and in some cases even less) is necessary to allow an unambiguous lane allocation at greater object distances. The aperture diameter D of an exemplary sensor is, for example, 75 (60) mm. The minimum possible half-power width resulting therefrom, for a single radar lobe, is 3.1° (3.8°). The actual half-power width is considerably larger, since the aperture coverage is not constant but instead the coverage decreases toward the edge. For aperture coverages that decrease toward the edge, the pre-factor in the formula above (590) increases to values of 80-1000, i.e. the half-power width ranges from 4.20 to 5.20 (for D=75 mm) or 5.20 to 6.50 (for D=60 mm).

DE 197 14 570 A1 discloses a multi-beam radar system in which more transmitting elements than receiving elements are present, the transmitting elements that are present being activatable both individually and in any simultaneous combination. The receiving elements can also be switched over. As a result, the observable angular region can be widened.

International Patent Application WO 2004/051308 A1 relates to a device for measuring angular positions using radar pulses and mutually overlapping antenna beam characteristics of at least two antenna elements. On the receiving side, a combined evaluation of received signals of at least two antenna elements is accomplished.

### SUMMARY OF THE INVENTION

With the features as described herein—i.e. in a radar system including: at least two transmitting antennas having two different directional characteristics, in particular for different distance ranges; a switcher for switching over between at least two different directional characteristics; at least two receiving antennas; an evaluation device for combined evaluation of the digitized signals of at least two receiving antennas in the manner of a correlation of the receiving antenna signals—a very wide horizontal sensing region, e.g. up to +/−40°, can be achieved at medium ranges (1 to 50 m), e.g. for early detection of “cutting-in” vehicles in this distance range, and a narrow horizontal sensing range, e.g. +/−6°, can be achieved at long ranges (80 to 150 m).

The different distance ranges can be switched over flexibly and, if applicable, dynamically. The possibility of using digital evaluation methods means that excellent angular separation can be achieved, in particular by way of parameter estimation methods. This allows reliable sensing of a narrow-lane situation, or separation of closely adjacent and, in some situations, very different vehicles. With the use of planar radiators, in particular patch elements, that are drivable individually or, in particular, in columns, a shallow installation depth can be achieved. The front-end design of the radar system is scalable, i.e. by way of specific embodiments the front end can be adapted to particular requirements, e.g. in terms of location field and range, and can thus be used, for example, at the rear of the vehicle for blind-spot monitoring, lane-change assistance, etc., optionally also with a different configuration of the digital signal evaluation system. The exemplary embodiments and/or exemplary methods of the present invention permits the use of modern evaluation methods whose angular separation capability is not directly correlated with the size of the radiating aperture but, theoretically, is in fact almost independent thereof.

Methods of this kind have been available since the mid-1980s under the designation “subspace-based parameter estimation methods.” The most important representatives are the MUSIC and ESPRIT methods. These approaches are based on the use of multiple parallel antenna elements on the receiving side, each having identical, mutually overlapping directional characteristics; and on the evaluation, using digital signal processing, of the correlation properties of these quasi-synchronously present parallel received signals. With a sufficient signal-to-noise (S/N) ratio at the receivers, these approaches allow highly precise angular separation even when the objects to be separated have very different reflectivities.

For the implementation of antenna arrangements of this kind, it is advantageous to use planar antenna structures, such as so-called patch antennas or other planar antenna structures such as dipoles, or short conductor pieces (“stubs”) that are not loaded at the end, which moreover offer the possibility of obtaining maximally flat front ends to minimize overall depth. To achieve maximum horizontal sensing without so-called “grating lobes” with corresponding ambiguities in terms of angle estimation, the parallel individual radiators may have a spacing on the order of half the free-space wavelength, i.e. approx. 2 mm at 77 GHz.

When parallel arrangements of this kind are used, it is possible to utilize so-called digital beam shaping methods, in which a collimated beam lobe is formed only by digital signal processing, rather than at the analog high-frequency level as in the case of a lens antenna or parabolic antenna. Digital beam shaping is particularly advantageous for the detection of distant objects, since it yields a sufficient S/N ratio and thus enables reliable location.

In existing front ends with digital beam shaping, the field of view is restricted to approx. +/−10° and is thus of only limited use for functions that require much wider azimuthal sensing of the environment in front of the vehicle.

With the exemplary embodiments and/or exemplary methods of the present invention, it is not necessary to create any beam lobes on the receiving side at the high-frequency level; instead, the received signals of individual antenna columns can be further processed in directly digital fashion or after corresponding digitization (digital beam shaping) for purposes of antenna signal correlation. In multi-target scenarios, the limitations that result from beam shaping at the digital level are circumvented by the fact that high-resolution estimation methods are used for angle determination.

### BRIEF DESCRIPTION OF THE DRAWINGS

FIG. 1 is a block diagram of a radar front end.

FIG. 2 shows an individual antenna element.

FIG. 3 shows series-fed antenna elements.

FIG. 4 shows parallel-fed antenna elements.

FIG. 5 shows an embodiment of transmitting antenna(s) having multiple individual radiators.

FIG. 6 shows another embodiment of transmitting antenna(s) having multiple individual radiators.

FIG. 7 shows a transmitting antenna embodied as an individual element.

FIG. 8 shows a transmitting antenna embodied with multiple individual elements and a special connection.

FIG. 9 shows a radar front end having two different local oscillator frequencies for the transmitting and the receiving branch.

FIG. 10 shows the switchover system between two transmitting antennas.

FIG. 11 shows the system for switching elements in and out within an antenna.

FIG. 12 shows a receiving concept expanded to include amplifiers and multiplexers.

FIG. 13 shows a receiving concept expanded to include amplifiers and multiplexers.

FIG. 14 shows a receiving concept expanded to include amplifiers and multiplexers.

FIG. 15 shows the distribution of the local oscillator signal with intermediate amplifiers.

### DETAILED DESCRIPTION

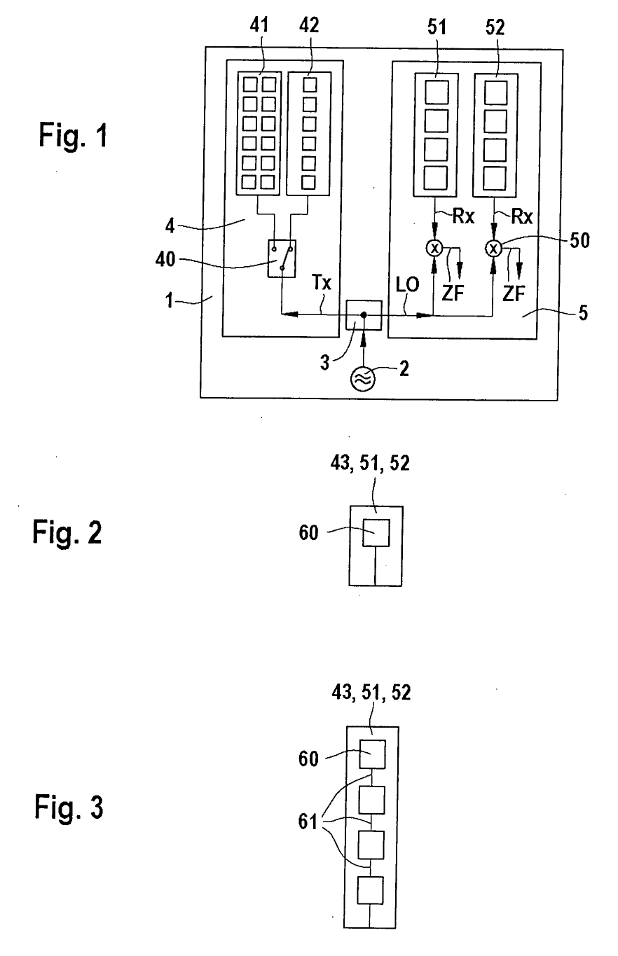

FIG. 1 is a block diagram of a radar front end 1. This front end 1 is made up specifically of:
a modulatable 77-GHz source 2 (so-called modulated local oscillator), stabilized optionally via a PLL and optionally via a DRO, which may be highly integrated into so-called MMICs;
   a transmitting unit 4 made up of:
at least two different transmitting antennas 41 and 42 using planar technology (patch antennas), of which one antenna 41 is designed so that by corresponding superimposition of the waves of the individual radiators belonging to antenna 41, it generates a comparatively strongly collimated antenna lobe; a further antenna 42 which is designed so that by corresponding superimposition of the waves of the individual radiators belonging to antenna 42, it generates a comparatively wide azimuthal antenna characteristic, or comprises only one radiator element; optionally further transmitting antennas which are designed so that they generate further specific transmission characteristics;
a 77-GHz switcher 40 for switching between the different transmitting antennas, i.e. between antennas 41 and 42 and optionally further antennas;
a receiving unit 5 made up of at least two parallel individual receiving radiators 51 and 52, and optionally further ones, using planar technology (patch antennas), whose received signals are mixed down by way of a mixer unit 50 in the immediate vicinity of the antenna into an intermediate frequency band (baseband); and
a power splitter 3 (so-called Tx-Rx power splitter) for distributing the local oscillator power of 77-GHz source 2 into the components required respectively in transmitting unit 4 and in receiving unit 5.

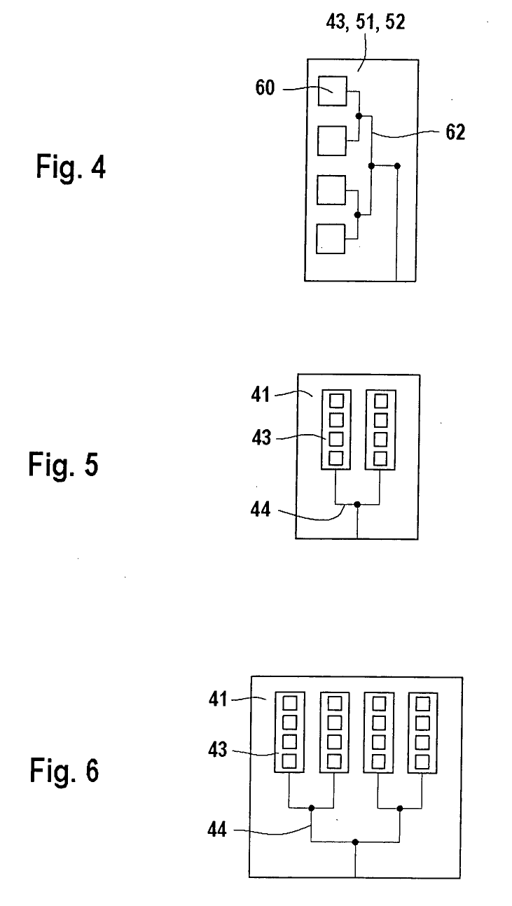

The respective individual radiators 43 of transmitting antennas 41, 42 and receiving antennas 51, 52 can be made up, as shown in FIGS. 2 to 4, of a single patch 60 or also of multiple patches disposed vertically above one another (antenna column). The latter is advantageous if further collimating units (e.g. cylindrical lenses) are omitted, for collimating the energy in the elevation plane, parallel to the plane of the road, on both the transmitting and receiving side. Feed to the patches in a column is accomplished as a serial feed 61, parallel feed 62 (corporate feed), or a combination thereof. A radiation-coupled feed, e.g. via a multi-layer slit patch or patch-to-patch couplings, is also possible. The antenna column may thus assumed to be disposed perpendicular to the road surface. Collimation in elevation could also be accomplished, on both the transmitting and receiving side, by the use of a cylindrical lens; an individual radiator could then be represented by a single patch. Its focal line would then coincide approximately with the center lines of the individual patches.

What is essential is that with reference to the azimuthal plane of transmitting unit 4, so-called analog beam shaping methods are to be used, whereas receiving unit 5 is configured so that, in combination with a downstream evaluation unit, so-called digital beam shaping methods are used. This is achieved substantially by way of individual receiving radiators disposed in parallel fashion, with a quasi-parallel further processing system optionally also guided via a multiplexing unit. It is only this digital approach on the receiving side, using individual receiving antennas or individual receiving radiators 51, 52 (and optionally further ones) operating in parallel, that allows the use of methods that make available excellent angular separation capability, i.e. much less than the half-power width of a collimated radar lobe.

Commercially available chips or chipsets using MMIC technology, or other 77-GHz-generating elements such as, for example, Gunn elements, can be used to constitute the 77-GHz source.

First transmitting antenna 41 is realized, as recited in FIG. 5, by using multiple individual radiators 43 and connecting them at the HF analog signal level 44. Analog connection 44, in the manner of a power divider, makes it possible e.g. to apply a specific amplitude distribution to the individual radiators. This distribution can be selected, for example, so that the so-called secondary lobes of antenna 41 assume a very low level below the main lobe, e.g. −30 dB. This makes it possible, in contrast to hitherto usual sensors, to keep interference due to the “illumination” of objects outside the main lobe very low. For example, the use of seven individual radiators in antenna 41 permits a main lobe width of +/−6.5°, decreasing the secondary lobes to −28 dB. FIG. 6 shows a variant with four columns of individual radiators 43.

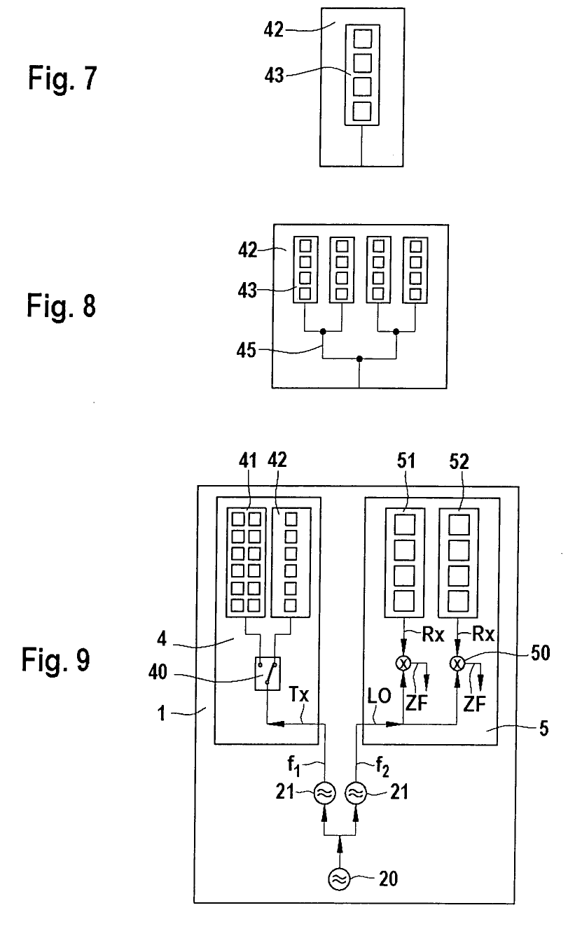

Second transmitting antenna 42 is used to achieve the widest possible azimuthal illumination. The use of a single radiator element in antenna 42 as shown in FIG. 7, for example, enables the use of a main-lobe width of approx. +/−40°. It is, however, also entirely possible, by specifically designing a multi-element antenna 42 having a special power divider 45 (as shown in FIG. 8), to achieve main-lobe widths greater than +/−40°.

The use of the highly collimating antenna 41 would make it possible to sense objects at a greater distance, e.g. 80 to 150 m, but only in a narrow angular region. This has the advantage that interference from roadside structures, in particular guard rails, can be very much reduced.

The use of the azimuthally widely radiating antenna 42 would make it possible to localize objects, for example, in the area in front of the own vehicle over a very wide azimuthal sensing region. Because the 77-GHz energy is not focused, however, but rather is “widely” radiated, more-distant objects receive little illumination, so that their reflections are weak and therefore also not disruptive. Antenna 41 would thus be the antenna for the long-range radar (LRR) mode, whereas antenna 42 would be used for the medium-range radar (MRR) or short-range radar (SRR) and would serve, for example, for prompt detection of cutting-in vehicles or other relevant objects in the outer (short- to medium-range) region. For the MRR/SRR modes, it is important that the individual receiving radiators 51, 52, and optionally further ones, exhibit a wide azimuthal radiating characteristic. The totality of the switching capabilities just described can be referred to as a universal-range radar (URR).

Further transmitting antennas can be used, for example, in order to generate further specific transmission characteristics, e.g. azimuthally or optionally even vertically swept beams, i.e. radar lobes whose maximum points not in the direction perpendicular to the front end but in other directions. Antennas 41 and 42 could also be designed a priori so that their main beam directions already possess directions differing from the direction perpendicular to the front end, for example to enable certain installation scenarios on the vehicle in which, for example, the sensor cannot extend perpendicular to the vehicle axis.

The respective transmitting antenna 41 or 42, or optionally others, that is used usually radiates a modulated 77-GHz signal. This can involve, for example, an FMCW, pulsed, FSK, pseudonoise (PN), or also other usual radar modulation methods, or even combinations of the aforesaid methods. The 77-GHz switcher 40 serves to switch between the different transmitting antennas, i.e. in switching mode a) only antenna 41 transmits, and in switching mode b) only antenna 42. With further switching modes, optional further antennas having further specific transmitting characteristics can radiate the transmitting power that is available. 77-GHz switchers of this kind are already available in integrated technology (MMICs), but can also be implemented by using so-called pin diodes in a discrete configuration.

Receiving unit 5, having individual receiving radiators 51 and 52 and optionally further ones, serves to receive waves reflected from individual objects. Depending on the type of modulation, conclusions can be drawn from a frequency offset, a transit-time difference, or a phase difference with respect to the transmitted signal about the distance, and via the so-called Doppler effect also about the relative velocity, of these objects. The reflected waves are furthermore incident onto the parallel individual receiving radiators in oblique fashion and thus with differing phase relationships, provided said objects exhibit a lateral offset from the line normal to the antenna front end. By analyzing these phase relationships, it is also possible to calculate the angular offset of these objects. Conventional methods, such as the monopulse method, perform this analysis by way of a quantitative comparison of multiple received signals from azimuthally overlapping beam lobes. The monopulse method can be performed with so-called analog-shaped beam lobes that can be generated e.g. via a dielectric lens, or these overlapping beam lobes are not generated until digital signal processing (digital beam shaping) takes place in the evaluating unit. Another method would be horizontal scanning of the sensed region using only one beam lobe; here the angular offset would need to be determined from the amplitude distribution as a function of angle. In all these so-called conventional angular estimation methods, however, the separation capability is limited to the half-power width (n) of the beam lobe (n).

The exemplary embodiments and/or exemplary methods of the present invention described here refers, in terms of the receiving unit, in particular to digital beam shaping. Firstly, the received signals, present in parallel fashion in the receiving unit, of multiple individual receiving radiators are mixed down via a mixing unit 50 into the analog baseband, amplified and filtered, digitized, multiplied in the processor unit by complex weighting factors, and lastly added; in other words, a correlation, in particular a weighted summation, of various individual radiators in the digital range is performed. This approach then likewise yields beam-shaped signals, but of an exclusively digital nature. For angle estimation, the monopulse method or continuous scanning can also be used. Also applicable, however, are methods that are not based on limiting the angle separation capability to the half-power width of the beam lobes. These so-called “subspace-based parameter estimation methods” analyze the correlation properties of the individual receiving radiators. The received signals are broken down into a so-called signal and noise subspace, creating the possibility of very good angle separation capability.

Power splitter 3 can be realized in the form of a so-called Wilkinson splitter, a so-called T splitter, a ring hybrid, or a line coupler. Further embodiments are a planar lens, e.g. Rotman lens, or a splitter having one or more integrated amplifiers (active power splitter), which can be constructed overall as an MMIC.

All the 77-GHz conductor elements may be configured using microstrip conductor technology, but the exemplary embodiments and/or exemplary methods of the present invention is independent thereof.

Alternative embodiments as well as implementation details are presented below:
more than two transmitting antennas;
more than two individual receiving elements;
77-GHz source implemented using MMICs or Gunn element;
77-GHz source stabilized/modulated using a PLL unit and optionally a DRO;
two sources 21 as shown in FIG. 9, having different frequencies f₁ and f₂, for the transmitting and receiving branch, with the result that the system operates on the receiving side at an intermediate frequency (sources can refer to a reference 20, e.g. by way of a splitter/PLL or multiplication).

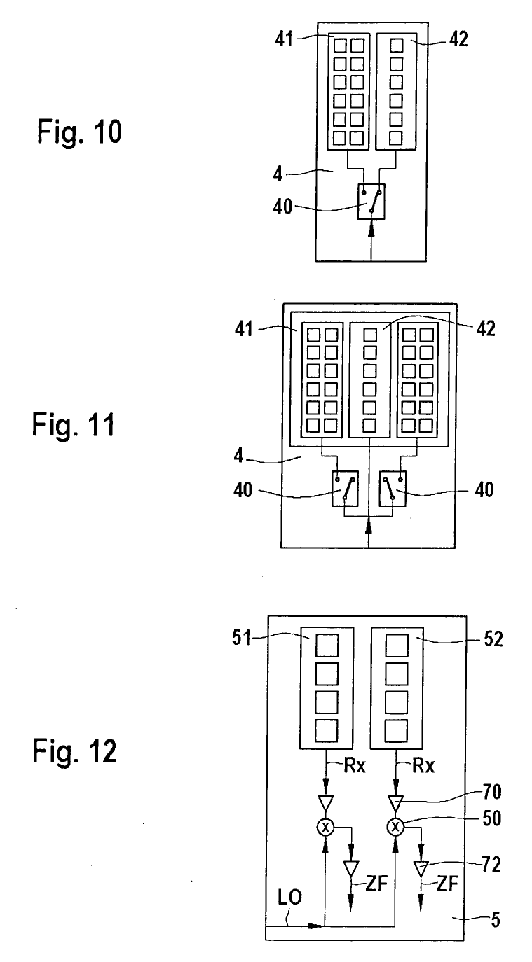

FIG. 10 shows a first embodiment of switcher 40 within transmitting unit 4 in the form of a switchover system between antennas 41 and 42, and FIG. 11 shows an embodiment in the form of a system for switching elements in and out within an antenna; switchover occurs between antennas 41 (portion of the entire antenna) and 42 (entire antenna).

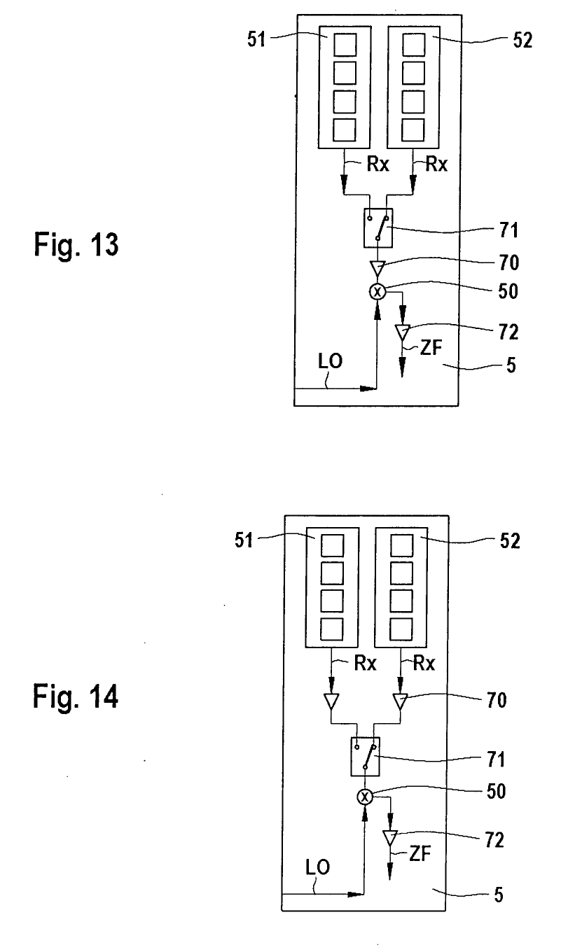

FIGS. 12 to 14 show receiving unit 5 supplemented with a low-noise amplifier (LNA) 70, multiplex unit 71, and IF preamplifier 72. In a first variant shown in FIG. 12, mixer unit 50 is supplemented with an LNA 70 and/or IF preamplifier 72. In a second variant shown in FIG. 13, one multiplex unit 71 switches multiple receiving antennas 51, 52 successively to mixer unit 50, which can be supplemented with an LNA 70 and/or IF preamplifier 72. The multiplex unit serves to reduce the number of receiving channels that require further processing. In a third variant shown in FIG. 14, multiplex unit 71 switches multiple receiving antennas 51, 52, having associated LNAs 70, successively to mixer unit 50, which can be supplemented with an LNA and/or IF preamplifier. The last variant is advantageous when the noise of the multiplex unit is too high.

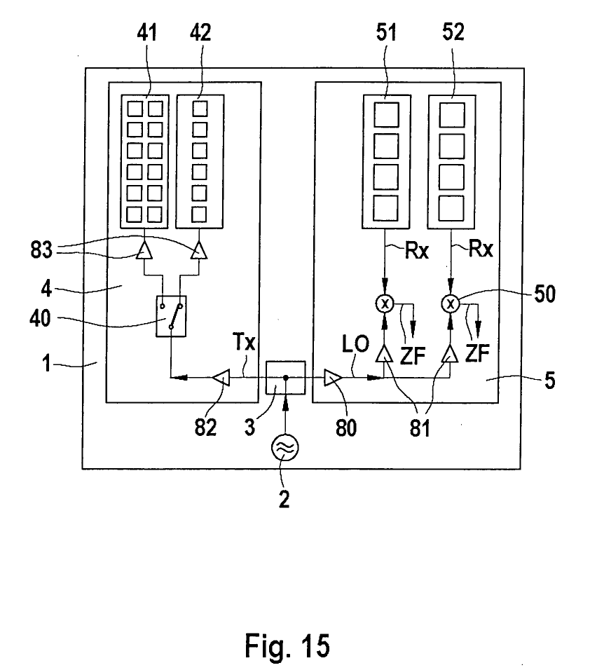

FIG. 15 shows the Tx-LO distribution system supplemented with amplifiers, which can be used at one or more of positions 80, 81, 82, 83. Preamplifier 80 between Tx-Rx power splitter 3 and mixer unit 50 of receiving unit 5, or preamplifier 81 within the LO system in the receiving unit for distribution to the individual mixers, serve to make available the requisite local oscillator power level for a sufficiently good mixing process (in terms of mixer conversion losses and additional mixer noise). Their use depends on the design of power splitter 3, the number of individual receiving radiators, and the mixer concept that is selected. Alternatively or additionally, an amplifier 82 between Tx-Rx power splitter 3 and transmitting unit 4, or one or more amplifiers 83 between antenna switcher 40 and one or more transmitting antennas 41, 42, can also be used.

Power splitter 3, switcher 40, mixer unit 50, the mixer unit supplemented with LNAs 70, multiplex unit 71, preamplifier 80, and IF preamplifier 72 can in part be of discrete construction, partially highly integrated into MMICs, or even all highly integrated together into an MMIC. The collimation properties in elevation of transmitting antennas 41, 42, and optionally of further ones, can be different. The collimation properties in elevation of individual receiving radiators 51, 52, and optionally of further ones, can likewise be different.

A frequency-modulated continuous wave (FMCW) modulation is often used in automobile radar systems. To allow distance and velocity information to be separated from one another, two or more modulation ramps having different parameters (e.g. ramp slope) must be used. The requisite allocation to one another of the frequency lines generated by the targets in the individual ramps is particularly difficult in the context of separate processing/digitization of the signals of individual (planar) elements (such as those used e.g. for the subspace-based parameter estimation method), since on the receiving side, no limitation of the antenna characteristic exists in azimuth, or at best there is a limitation to the region of the short-range/MRR mode. In principle, therefore, reflections are received from all targets in the sensing range of the receiving antenna, so that allocation of the frequency lines to one another becomes very difficult simply because of the number of targets. At long range in particular, the number of detected targets in the sensing range of the receiving antennas can become extremely large. Additional actions must therefore be taken to ensure, to the extent possible, that only signals from targets that are relevant to the respective operating state are received or processed. The following actions may serve this purpose:
the characteristic of the transmitting antenna for long range is restricted to a relatively narrow angular region on the order of +/−4° to +/−8°, so that curves are still sufficiently illuminated on expressways, but otherwise only targets in the straight-ahead region are irradiated. The secondary lobes of the transmitting antenna must moreover be suppressed as much as possible, since targets at short range, including e.g. guard rails, that are irradiated by the secondary lobes would otherwise lead to relatively strong received signals.
This makes it necessary to introduce a second operating state for short range. In this operating state a transmitting antenna having a wide azimuthal beam characteristic is used, since for applications in city traffic (e.g. stop-and-go driving), pre-crash functions, etc., a large angular region in azimuth, e.g. +/−60°, must be covered.
Because the range required in the short-range operating state is not very great, the transmitting power can be reduced, in addition to the already lower antenna yield because of the wide main lobe, coupled with the switchover to short range. This decreases the range, in desirable fashion.

Targets that are not located in the distance range covered by the respective operating state can be suppressed for FMCW modulation by way of a suitable filter for the baseband signals that is switched over along with the operating state. The baseband frequency resulting from the distance is much greater than the baseband frequency caused by the Doppler shift. It is thus possible, for example, to suppress the close-in targets with a high-pass filter for long range, and suppress the remote targets with a low-pass filter for short range. Because of the distance uncertainty caused by the Doppler components, a certain overlap of the passthrough regions must be provided for the filter cutoff frequencies. The aforesaid filter characteristic usually also has an additional high-pass characteristic overlaid on it. The latter serves to partially equalize the distance dynamics (received power is proportional to R⁻⁴). The modulation parameters (e.g. ramp slope for FMCW) must be selected accordingly.

The reduction, as described here, of the number of detected targets to the angle region relevant in the respective distance range furthermore has a favorable effect on target tracking. The target detection quality of an FMCW ramp pass is generally not sufficiently good that every target is reliably detected and its position determined. Ghost echoes also occurs, as well as frequency line allocations that cannot be unequivocally resolved. These uncertainties can be eliminated if targets are stored in a target list and tracked over multiple ramp passes, optionally with prediction of the expected position and confirmation of a target only after it has been consistently detected several times. This so-called tracking process becomes increasingly difficult and computation-intensive as the number of targets to be processed rises. A reduction in the number of targets to be processed is very useful here as well.

An input level range from −120 to +5 dBm should be tolerated by the input stage (mixer) and optionally LNA. In long-range mode, overmodulation of the input stage is acceptable provided only intermodulation products of the strong signals from short range occur. These intermodulation products are located in the baseband, just like the associated input signals, at low frequencies, and are removed by the above-described switchable filters. In short-range mode, on the other hand, the transmitting power must be lowered until no further overmodulation and intermodulation occur.

For digitization using sufficiently fast and economical A/D converters, the dynamics in the baseband must be limited to range of approximately 60 dB (10 bits). This is achieved, in long-range mode, by way of the high-pass characteristic of the LF signal path, for which purpose components at lower frequencies are suppressed. The demands on the switchable filter, and on the LF amplification switching system connected thereto, can be reduced by reducing the transmitting power for short range.

If the column spacing is greater than half the free-space wavelength, ambiguities in angle determination occur (analogous to grating lobes=higher-order diffractions during beam shaping). Therefore, either the column spacing must not be significantly larger than half the free-space wavelength, or the secondary lobes of the transmitting antenna in the region of the grating lobes must be so small that targets can longer be detected in them.

The height of the targets in elevation is a maximum of 4 m (trucks), typically approx. 2 m. Because it is not known a priori which regions of a vehicle represent the strongest radar targets, passenger cars and motorcycles at long range should be irradiated to approximately their full height (trucks generally present substantially stronger radar targets). At short range, targets need not be sensed to their full height, since the shorter distance means that even weaker reflection centers on the target produce an adequate received signal. The width of the beam lobe should furthermore encompass a certain tolerance for pitching and/or loading of the vehicle. A beam angle of typically 3 to 4° is thus sufficient for long range (2 m height at a distance of 30 m). At the same time, this narrow main lobe reduces reflections from the ground, which result in undesired signals or non-existent targets (clutter).

A beam angle of 4° at a distance of 3 m, however, illuminates a region only about 20 cm high, in which a reflection center would need to be located. For short range, an enlargement of the beam angle to approx. 5 to 20° (1 m high at a distance of 3 to 10 m) is therefore necessary. It should be sufficient to irradiate the regions in which the strongest reflections usually occur (license plate and surrounding areas, wheel wells, etc.).

The important features are summarized once again below:
transmitting antenna switchover for two distance ranges;
short range: widest and flattest possible characteristic for detection of radar targets out to a first distance limit (or frequency limit for FMCW modulation;
long range: main lobe is configured so that the straight-ahead region on expressways or main highways is covered, including typical curve radii (typically +/−8°, advisable range approximately +/−4° to +/−12°), and smallest possible secondary lobes (typically −30 dB and lower); detected radar targets are processed only beyond a second distance limit (or frequency limit for FMCW modulation);
overlapping distance limits;
digital processing on the receiving side, in particular multiple antenna columns fed into the baseband and digitized; a switchover of columns can also occur;
columns of receiving antennas having a wide beam characteristic in azimuth, for example individual patches disposed in elevation to form one column.

Optionally, these features can also be combined with at least one of the following features:
1. Transmitting antenna for long range has a relatively narrow lobe in elevation, approximately 3 to 5°; transmitting antenna for short range has a wider main lobe in elevation, e.g. 20°;
2. Switchover of the baseband filter characteristic, if applicable with amplification switchover;
3. Reduction in transmitting power for the short-range mode;
4. Modulation switchover (FMCW parameters or other modulation principle: Doppler, pulsed Doppler, FSK);
5. Switchable LNAs upstream from the mixers;
6. Use of high-resolution angle estimation methods together with digital beam shaping and conventional evaluation methods.

1-13. (canceled)

14. A radar system, comprising:
at least two transmitting antennas having different directional characteristics for different distance ranges;
a switcher for switching over between at least two different transmitting characteristics;
at least two receiving antennas; and
an evaluation device for providing a combined evaluation of the digitized signals of the at least two receiving antennas based on a correlation of receiving antenna signals.

15. The radar system of claim 14, wherein there is digital beam shaping on the receiving side.

16. The radar system of claim 14, wherein the evaluation device provides that the detection of radar targets is selectable according to the distance ranges.

17. The radar system of claim 14, wherein a wide horizontal directional characteristic is provided for a close range, and a narrow directional characteristic is provided for a distant range.

18. The radar system of claim 14, wherein the directional characteristics are implemented by overlaying the directional characteristics of multiple individual antenna elements.

19. The radar system of claim 14, further comprising: a modulatable local oscillator having a power splitter for distributing local oscillator power for the transmitting antennas and the receiving antennas.

20. The radar system of claim 14, wherein signals of the at least two receiving antennas can be mixed down into an analog baseband via a mixer unit, digitized and then multiplied by complex weighting factors and added.

21. The radar system of claim 14, wherein the signals of the at least two receiving antennas estimated with a subspace-based parameter estimation procedure for analysis of their correlation properties.

22. The radar system of claim 14, further comprising: a receiving-side multiplex unit, the signals of multiple receiving antennas being successively switchable to a mixing unit.

23. The radar system of claim 14, wherein at least one of the different distance ranges and the directional characteristics associated with them are embodied in overlapping fashion, and processing of the detected radar targets is performed only as of a predetermined minimum distance limit.

24. The radar system of claim 14, wherein at least one of individual patch radiators and columns of individual radiators, which are operable with one of serial feed and parallel feed, are provided as antenna elements.

25. The radar system of claim 14, further comprising: a switchable baseband filter to suppress targets outside a selected distance range.

26. The radar system of claim 14, further comprising: a reducing arrangement to reduce transmitting power for operation in a close range.
